(19) United States
(12) Patent Application Publication
(10) Pub. No.: US 2011/0299112 A1
(43) Pub. Date: Dec. 8, 2011

(54) CLOUD COMPUTING SYSTEM, METHOD FOR PROCESSING DOCUMENT, AND STORAGE MEDIUM FOR SAME

(75) Inventor: Shunsuke Ota, Kawasaki-shi (JP)

(73) Assignee: CANON KABUSHIKI KAISHA, Tokyo (JP)

(21) Appl. No.: 13/109,872

(22) Filed: May 17, 2011

(30) Foreign Application Priority Data
Jun. 2, 2010 (JP) 2010-126451

(51) Int. Cl. G06K 15/02

(52) U.S. Cl. 358/1.15

(57) ABSTRACT

A front-end processing unit provided in a document processing system receives a request in relation to document processing from an image forming apparatus, and produces a divided job by dividing the document processing job into a unit capable of parallel processing in response to the received request details. The front-end processing unit determines an execution order for each of the divided jobs, and then stores the divided jobs in a plurality of queues. The back-end processing unit obtains a divided job from the queue according to the determined execution order of divided jobs, and executes document processing by executing the obtained divided job, and then returns the document processing result to the image forming apparatus.

### BACKGROUND OF THE INVENTION

1. Field of the Invention

The present invention relates to a cloud computing system, a method of processing documents, and a storage medium for same.

2. Description of the Related Art

In recent years, a technology termed a cloud computing system has attracted attention due to enabling use of various types of applications that operate via a server on the Internet. The cloud computing system is adapted to start up a plurality of virtual computers (Virtual Machines: VM) in response to the quantity of transactions or a server load. As a result, parallel processing is enabled by executing processing using the plurality of VMs. One example of the services that can be used via a cloud computing system is a driver-less printing service. These printing services are executed by without installing a driver on a personal computer (PC), and are executed by provision of a print data conversion service in the application server on the VM, and by production of print data by use of the mounted print data conversion service.

Japanese Patent Application Laid-Open No. 2008-293313 discloses a printing control apparatus that determines a number of calculation apparatuses (decomposers) to be started up for execution of print data conversion processing by reference to an information amount per page of print data, or a number of pages, and then executes parallel processing using the suitable number of calculation apparatuses.

### SUMMARY OF THE INVENTION

The cloud computing system according to the present invention produces divided jobs by dividing a job that is ordered for processing, and executes document processing of each of the divided jobs in a suitable execution order.

According to an aspect of the present invention, a cloud computing system is provided that includes a request reception unit configured to be realized by executing a request reception program that stores a message corresponding to a job in a storage unit in response to the reception of a processing request for the job from an image forming apparatus, and a back-end processing unit configured to be realized by executing a back-end processing program that makes an acquisition request for the message to the storage unit at regular intervals, and when the message has been acquired from the storage unit, performs processing based on the acquired message. The request reception unit includes a storing unit configured to receive a processing request for the job from the image forming apparatus, divide the received job, determine the execution order for each of the divided jobs, and store a message corresponding to each of the divided jobs in a plurality of the storage units. The back-end processing unit includes a document processing unit configured to obtain a message stored in any one of the plurality of storage units in accordance with the determined execution order for the divided jobs, execute document processing for the divided job based on the obtained message, and store the document processing result in the storage unit.

Further features of the present invention will become apparent from the following description of exemplary embodiments with reference to the attached drawings.

### BRIEF DESCRIPTION OF THE DRAWINGS

FIG. 1 illustrates an overall configuration of a system according to a first exemplary embodiment.

FIG. 2A illustrates an example of a hardware configuration for a server.

FIG. 2B illustrates an example of a hardware configuration for an image forming apparatus.

FIG. 3 is a block diagram illustrating an example of the functions of the system according to the present exemplary embodiment.

FIG. 4 illustrates a platform system for realizing a document processing system.

FIG. 5A illustrates an example of a queue management table.

FIG. 5B illustrates an example of a message management table.

FIG. 6 illustrates an example of a message stored in the queue.

FIG. 7 is a flowchart describing a registration process for a message in the queue.

FIG. 8 illustrates a transmission process for print data from the document processing system to the image forming apparatus.

FIG. 9 is a flowchart describing document processing in relation to the back-end processing unit.

FIGS. 10A to 10C illustrate an example of a message stored in the queue.

FIG. 11 is a flowchart describing registration processing for a message in the queue.

FIG. 12 is a flowchart describing document processing by the back-end processing unit.

### DESCRIPTION OF THE EMBODIMENTS

Generally, when a system executes parallel processing using a plurality of calculation apparatuses, there is no accurate standard for determining the relationship between the number of calculation apparatuses and the number of objects for processing. Consequently, there are difficulties associated with calculation of an optimal number of calculation apparatuses required for processing operations.

The printing control apparatus disclosed in Japanese Patent Application Laid-Open No. 2008-293313 determines a startup number of calculation apparatuses based on a reference standard that undergoes large fluctuation over time, such as the residual capacity of a memory, or the like. However, since a certain amount of time is required for starting up a VM in a cloud computing system, there are difficulties associated with varying the startup number of VMs instantaneously. For example, when a process is commenced by the system after waiting for the startup time of a VM, time is required for outputting the result of the process. Although it may be proposed to startup the VM in advance, such a configuration will cause a VM to be unnecessarily started up, or result in a configuration in which the number of VMs that are started up will be insufficient.

In a conventional system, a job for print data conversion processing for a single contents is divided into units that are capable of parallel processing, and a plurality of queues are used for parallel processing. Such a system does not execute processing by determining a suitable execution order for jobs that are stored in the plurality of queues. The system according to the present exemplary embodiment as described below solves the above problem.

The present exemplary embodiment will be described below making reference to the attached figures. Firstly, the general definitions of terms used in relation to the present exemplary embodiment will be described. “Polling” is a process in which a client makes an enquiry about the elapse state of a processing to a host at a predetermined interval in order to confirm the elapsing or completion of a processing requested from the host by the client. “Contents” is electronic data that combines document data or image data. A “print data conversion process” is a process in which an image forming apparatus such as a multifunction peripheral (MFP), a printer, or the like converts the contents that a user wants to print into print data. “Print data” is data resulting from processing and conversion of contents in a print data process. For example, print data includes page description language (PDL), portable document format (PDF), or a raster image.

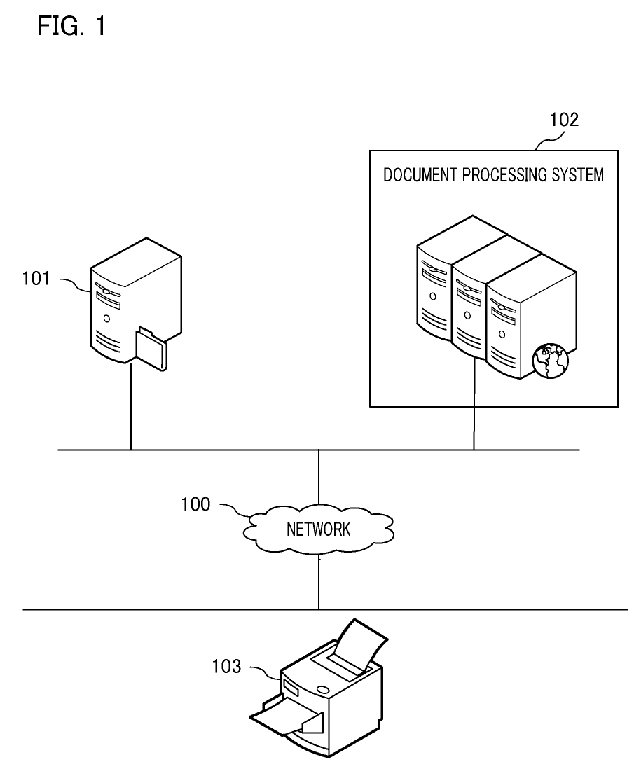

FIG. 1 illustrates the overall configuration of a system according to the present exemplary embodiment. The system illustrated in FIG. 1 includes a document repository 101, a document processing system 102, and an image forming apparatus 103. The document repository 101, the document processing system 102, and the image forming apparatus 103 are connected through a network 100. The network 100 may have a cable or a wireless configuration.

The document repository 101 is a processing apparatus configured to store a contents, and to provide the contents to the image forming apparatus 103 in response to a request from the image forming apparatus 103. The image forming apparatus 103 is configured to execute a printing request on the document processing system 102, to receive print data from the document processing system 102 that responds to the printing request, and to execute printing processing of the received print data. The image forming apparatus 103 is disposed in a local area with restricted external access, and is separated by a firewall from the network 100. The document processing system 102 includes a server group that includes a plurality of servers 200.

The document processing system 102 is configured to receive a printing request from the image forming apparatus 103, execute processing in response to the printing request for the contents stored in the document repository 101 to thereby produce print data, and to send the produced print data to the image forming apparatus 103. The document processing system 102 is a cloud computing system provided in a cloud. A “cloud” is a region in which a server group is disposed in a cloud computing environment. In the cloud computing environment, a user uses the computing processing as a service via the network. Access through the firewall is not permitted on the basis of a request produced from the document processing system 102 provided in the cloud. Therefore, the document processing system 102 communicates with the image processing apparatus 103 by returning a response to the request from the image processing apparatus 103. The document processing method according to the present exemplary embodiment is realized by a document processing system 102 as illustrated in FIG. 1. Furthermore, a computer program according to the present exemplary embodiment executes the document processing method using a computer.

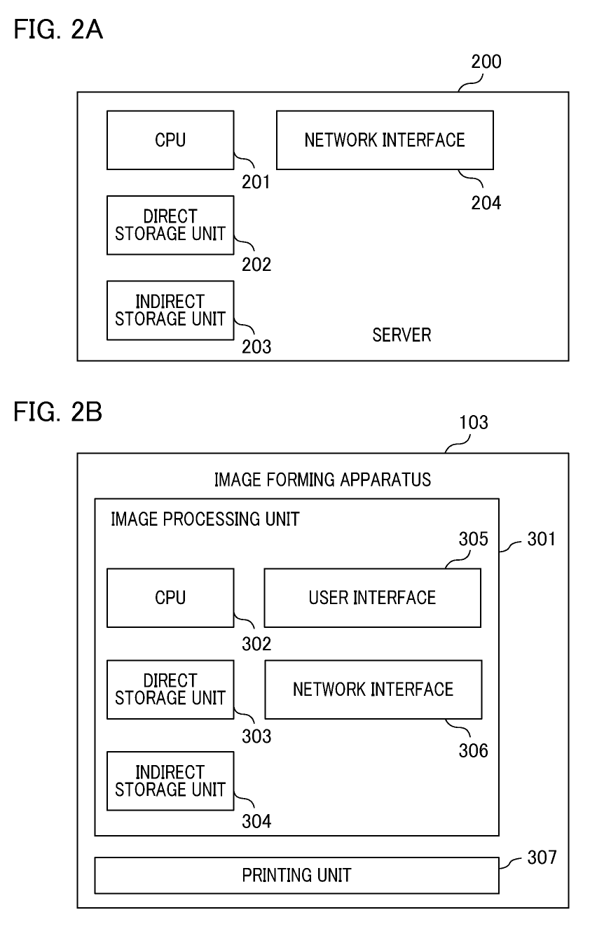

FIG. 2A illustrates an example of a hardware configuration of a server 200 provided with the document processing system 102. The server 200 includes a central processing unit (CPU) 201, a direct storage unit 202, an indirect storage unit 203, and a network interface 204.

The CPU 201 is a processing unit that is configured to execute a predetermined program and instruct various types of control for the server 200. The direct storage unit 202 is a work memory used when the CPU 201 executes a program. The program is loaded into the direct storage unit 202. The direct storage unit 202 includes a random access memory (RAM). Various types of programs including an application program and an operating system (OS) are stored in the indirect storage unit 203. Various types of programs stored in the indirect storage unit 203 are transferred to the direct storage unit 202 when the CPU 201 executes a program. The indirect storage unit 203 includes a read only memory (ROM) or a hard disc drive (HDD). The CPU 201 may be a multiprocessor. The network interface 204 is connected to the network 100 and mediates communication with the other apparatuses that are connected with the server 200 and the network 100.

FIG. 2B illustrates an example of a hardware configuration for the image forming apparatus 103. The image forming apparatus 103 includes an image processing unit 301 and a printing unit 307. The image processing unit 301 acquires print data from the document processing system 102, and executes a predetermined image processing on the print data. The printing unit 307 prints the print data that is image-processed by the image processing unit 301.

The image processing unit 301 includes a CPU 302, a direct storage unit 303, an indirect storage unit 304, a user interface 305, and an network interface 306. The CPU 302 is a unit configured to execute various programs and to instruct various types of control for the image processing unit 301. The direct storage unit 303 is a working memory used when the CPU 302 executes the programs. These programs are loaded onto the direct storage unit 303. The direct storage unit 303 is realized by the RAM. Various types of programs including application programs are stored in the indirect storage unit 304. The various types of programs that are stored in the indirect storage unit 304 are transferred to the direct storage unit 303 when the CPU 302 executes the programs. The indirect storage unit 304 is realized by a solid state drive (SSD) or an HDD. The CPU 302 may be a multiprocessor. The user interface 305 includes the function of receiving input from the user. The user interface 305 receives an input from a user through an apparatus such as a touch panel, a mouse, a keyboard, or the like. The network interface 306 is connected to the network 100, and mediates communication with the other apparatuses that are connected with the network 100.

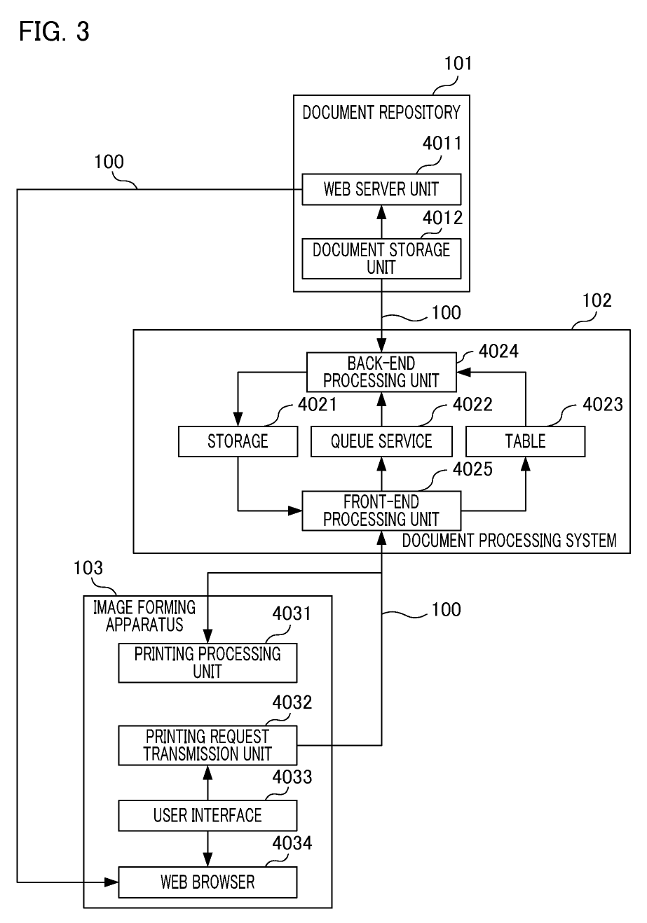

FIG. 3 is a block diagram illustrating an example of the functions of the system according to the present exemplary embodiment. The document repository 101 includes a Web server unit 4011 and a document storage unit 4012. The Web server unit 4011 is configured for example to receive a request from the document processing unit 102 and the image forming apparatus 103, and to execute processing in accordance with the request. The document repository 101, for example, receives an HTTP request for acquisition of a document list from the web browser 4034 of the image forming apparatus 103, and returns the information in relation to each contents type stored in the document storage unit 4012. The document storage unit 4012 is realized by the indirect storage unit 203 in FIG. 2B. There is no particular designation with respect to the contents stored in the document repository 101 or the method of storage of contents.

The document processing system 102 includes a storage 4021, a queue service 4022, a table 4023, a front-end processing unit 4025, and a back-end processing unit 4024. The storage 4021 has the function of storing various types of data, principally data related to execution results of processing by the back-end processing unit 4024. The storage 4021 is realized by the indirect storage unit 203 illustrated in FIG. 2B. The queue service 4022 includes a queue. The queue service 4022 has the function of enabling asynchronous data communication by the front-end processing unit 4025 and the back-end processing unit 4024. The queue service 4022 includes the function making a message that is added to the queue visible or invisible. The queue service 4022 is realized by loading of queuing programs stored in the indirect storage unit 203 illustrated in FIG. 2B onto the direct storage unit 202 for execution by the CPU 201. Furthermore, a queue included on the queue service 4022 is realized by the indirect storage unit 203.

The table 4024 has the function of a storage unit for storing information including the state of processing, or the like. The front-end processing unit 4025 is a request reception unit configured to store a message corresponding to a job in the queue that is the storage unit, in response to the reception of the processing request for the job from the image forming apparatus 103. The front-end processing unit 4025 is realized by executing request reception programs. The front-end processing unit 4025 receives a processing request for a job from the image forming apparatus 103, and divides the received job. The front-end processing unit 4025 includes a storing unit configured to determine an execution order for respective jobs that have been divided, and store a message corresponding to each of the divided jobs in a plurality of queues.

More specifically, the storing unit provided in the front-end processing unit 4025 receives a request related to document processing from the image forming apparatus 103 (for example, a printing request, print data request). The printing request is a request for execution of print data conversion processing. The print data request is a request that requests the sending of print data obtained by the print data conversion processing. The front-end processing unit 4025 has the function of communicating the processing details to the back-end processing unit 4024 through a plurality of queues in the queue service 4022. The front-end processing unit 4025 is configured to divide the document processing job into a unit that is capable of parallel processing in response to the received request details to thereby produce a divided job, determine an execution order for each of the divided jobs, and then store a message including the divided jobs in a plurality of queues. The message is information that includes a job related to document processing.

The back-end processing unit 4024 makes a message acquisition request to the queue at regular intervals, and, when the back-end processing unit acquires a message from the storage unit, the back-end processing unit performs processing based on the acquired message. The back-end processing unit 4024 is realized by executing the back-end processing programs. The back-end processing unit 4024 includes a document processing unit. The document processing unit obtains the message stored in any of the plurality of queues in accordance with the execution order of divided job determined by the front-end processing unit 4025. The document processing unit executes document processing of the divided job based on the obtained message, and then stores the document processing result in the storage unit.

More specifically, the back-end processing unit 5031 acquires the message from the queue in accordance with the execution order of divided job determined by the front-end processing unit 4025. The back-end processing unit 5031 obtains the divided jobs from the acquired message, performs document processing by executing the obtained divided job, and returns the document processing result to the image forming apparatus 103. The front-end processing unit 4025 and the back-end processing unit 4024 can enable asynchronous processing by adapting the job for transfer to the back-end processing unit 4024 from the front-end processing unit 4025 using the queue.

The back-end processing unit 4024 executes processing by loading processing programs onto the memory of the server corresponding to the back-end processing unit 4024. The function of the front-end processing unit 4025 is realized by loading the front-end processing programs stored in the indirect storage unit 203 illustrated in FIG. 2B into the direct storage unit 202 for execution by the CPU 201. In the same manner, the function of the back-end processing unit 4024 is realized by loading the back-end processing programs stored in the indirect storage unit 203 illustrated in FIG. 2B into the direct storage unit 202 for execution by the CPU 201.

The image forming apparatus 103 includes a printing processing unit 4031, a printing request transmission unit 4032, a user interface 4033, and a web browser 4034. The printing processing unit 4031 is configured to execute printing processing of the print data. The printing request transmission unit 4032 is a program that is configured to send printing settings or the like that are designated by the user interface 4033 to the front-end processing unit 4025 of the document processing system 102, and receives the corresponding reply. The user interface 4033 is an interface configured for use by a user of various types of applications provided by the printing apparatus 103. The image forming apparatus 103 executes various types of applications in accordance with user operations inputted through the user interface 4033. The web browser 4034 includes the function of configuring data or information stored in a device connected through the network 100 for perusal by a user. The web browser 4034 is realized by loading a program stored in the direct storage unit 303 illustrated in FIG. 2A into the indirect storage unit 304 for execution by the CPU 201. The user may peruse contents on the network 100 using the web browser 4034, and select and instruct printing using the user interface 4033.

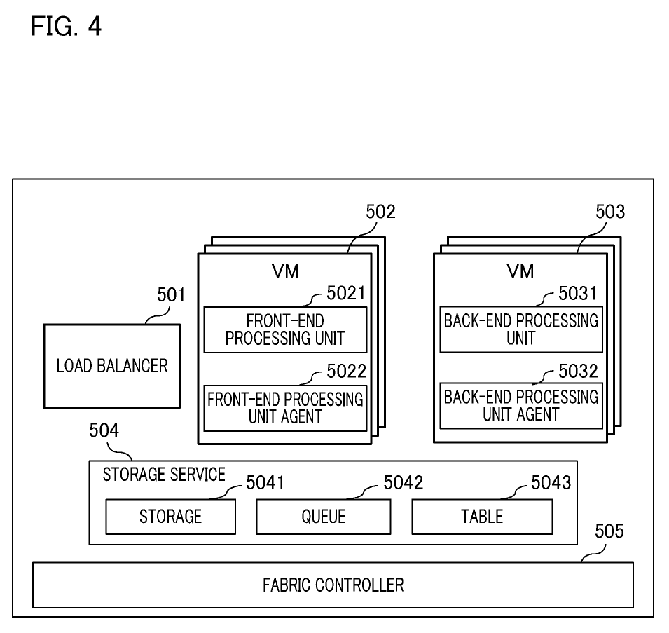

FIG. 4 illustrates a platform system for realizing a document processing system. A user can use the physical hardware resources of the server 200 provided in the document processing system 102 as a computing resource. The platform system illustrated in FIG. 4 includes a load balancer 501, a virtual machine (VM) 502, 503, a storage service 504, and a fabric controller 505. A plurality of VMs 502, 503 is provided in an inner portion of the platform system. The VM is a logical computer that divides the physical server into a logical computer using a virtual technique, and operates in a configuration of an independent operating system in the divided environment. A unit of the logical computer is termed an “instance”.

The VM 502 includes a front-end processing unit 5021 and a front-end processing unit agent 5022. The front-end processing unit 5021 is configured to receive a processing request from the user through the load balancer 501. The front-end processing unit 5021 includes a function of receiving a request from an external network. The front-end processing unit 5021 includes the function of sending the processing request to the back-end processing unit 5031 through the queue 5042 as described below. The request from the external network (for example, communication by HTTP) for conserving a high level of availability of the front-end processing unit 5021 is performed through the load balancer 501 that is in an external unit of the VM 502. The load balancer 501 executes unified management of requests from the external network, and transfers the selected request to the plurality of VMs that have an equivalent request reception function. The front-end processing unit agent 5022 accumulates various types of information including error information for the front-end processing unit 5021, the use state of the resources in the VM 502, the operational state of the front-end processing unit 5021, and the use state of the VM 502. The front-end processing unit agent 5022 sends the various types of accumulated information to the fabric controller 505 at regular intervals.

The front-end processing unit 5021 can access the fabric controller 505 only through the front-end processing unit agent 5022. The front-end processing unit 5021 and the back-end processing unit 5031 are managed by the fabric controller 505. In this manner, the extendibility and availability of each instance are assured. For example, it may be assumed that a specific instance in the front-end processing unit 5021 or the back-end processing unit 5031 is stopped by a malfunction of the server. In this situation, the fabric controller 505 can no longer receive the notification at regular intervals from the front-end processing agent 5022 or the back-end processing agent 5032. The fabric controller 505 that can no longer receive the notification at regular intervals outputs an instruction to the VM 502 to transfer processing to a new instance. As a result, a delay in processing can be suppressed by maintaining a fixed number of instances for execution of processing.

The VM 503 is configured by a back-end processing unit 5031 and a back-end processing unit agent 5032. The back-end processing unit 5031 receives the processing request from the front-end processing unit 5021 through the queue 5042 and performs processing. In the same manner as the front-end processing unit 5021, the back-end processing unit 5031 also accesses the fabric controller 505 through the back-end processing unit agent 5032.

The front-end processing unit 5021 and the back-end processing unit 5031 can be scaled out. “Scaling out” means that the number of VMs 502, 503 is increased to thereby increase the instances of the front-end processing unit 5021 and the back-end processing unit 5031. In this manner, even when traffic is increased as a result of an increase in the number of users, the load can be distributed by scaling out of the front-end processing unit 5021. The data processing amount per back-end processing unit can be reduced by scaling out of the back-end processing unit 5031. Consequently, the result of a processing request from a user can be more promptly returned.

The storage service 504 includes a storage 5041, a plurality of queues 5042, and a plurality of tables 5043. The queues 5042 are adapted to enable asymmetrical data communication by the front-end processing unit 5021 and the back-end processing unit 5031. The front-end processing unit 5021 and the back-end processing unit 5031 execute asymmetrical data communication by outputting various types of instructions to the queue 5042. An instruction that is executed by the front-end processing unit 5021 on the queue 5042 is an addition instruction for the message. An instruction that is executed by the back-end processing unit 5031 on the queue 5042 is a message acquisition instruction or a message delete instruction.

The series of operations for asynchronous communication by the front-end processing unit 5021 and the back-end processing unit 5031 will now be described. The front-end processing unit 5021 prepares a message corresponding to the processing request from the user, and sends an addition instruction to the queue 5042 to add the message to the queue. The queue 5042 that receives the addition instruction adds the message to the queue. The back-end processing unit 5031 outputs an acquisition instruction to the queue 5042 in order to acquire the message. The queue 5042 that has received the acquisition instruction returns the message, the message ID that is allocated individually to each message, and the receiving ID to the back-end processing unit 5031 as a response to the acquisition instruction. The message ID is individual information allocated to each message for unique designation of the message. The receiving ID is used when the back-end processing unit 5031 that has completed processing executes a deletion instruction for the message. The message, the message ID and the receiving ID are stored in association.

When the back-end processing unit 5031 completes the processing request, a deletion instruction for the message corresponding to the receiving ID is performed with respect to the queue 5042. The queue 5042 that has received the deletion instruction deletes the message corresponding to the receiving ID instructed by the back-end processing unit 5031 from the queue. In this manner, redundant processing such as deletion of the same message by a back-end processing unit 5031 other than the back-end processing unit 5031 that has outputted the deletion instruction can be prevented.

Next, the details of the function of making the message added to the queue 5042 visible or invisible will be described. The invisible function is a function in which after one back-end processing unit 5031 has acquired a message from the queue, other back-end processing units 5031 are placed into a state in which the message cannot be acquired (an invisible state) to thereby prevent acquisition of the same message by another back-end processing unit 5031. As used herein, an “invisible period” refers to the period until a state in which a message can be acquired on a subsequent occasion (visible state). An arbitrary period may be set as the invisible period when the front-end processing unit 5021 prepares a queue. When the back-end processing unit 5031 has not completed processing during the invisible period, a visible state will be entered, and the back-end processing unit 5031 re-acquires the message for processing.

If the back-end processing unit 5031 crashes for some reason during processing and continuous processing becomes impossible, reprocessing is not possible during the invisible period. When the processing time exceeds the invisible period, a message that has not been completely processed will become visible, and since processing by the other back-end processing units 5031 will commence, deletion is not possible. Consequently, the invisible period set in the queue 5042 must be longer than the processing time for an arbitrary message stored in the queue 5042. However, when the invisible period is excessively long, in the event of a crash by the back-end processing unit 5031, time will be required until reprocessing is executed. Therefore, when the front-end processing unit 5021 stores a message in the queue 5042, the message is subjected to a grouping process that approximates the processing time for the job (divided job) contained in the message (to achieve the same execution processing cost). The front-end processing unit 5021 stores the grouped messages in the queue 5042.

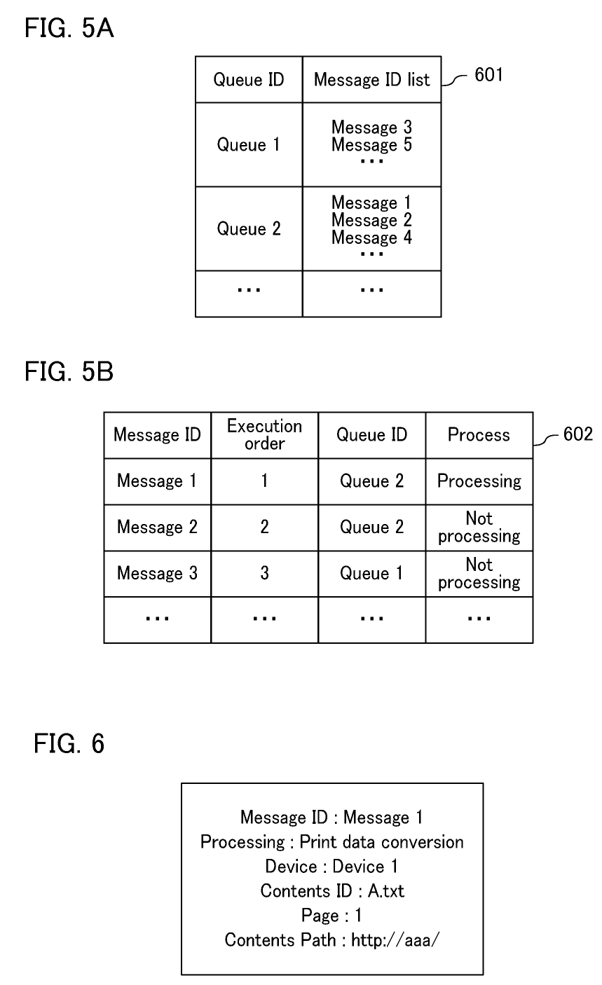

The storage 5041 provides a storage region that is used for data preservation. Metadata can be associated in the storage 5041. The metadata is expressed by the pair formed by a name and a value. The metadata can be acquired and set independently to the data. A plurality of tables 5043 is provided on the storage service 504. The respective tables 5043 are designated by a unique name. In the present exemplary embodiment, the table 5043 includes a queue management table 601 (refer to FIG. 5A), and a message management table 602 (refer to FIG. 5B). A platform user can access the tables based on the respective table names. The tables 5043 are mainly used to retain the state of the services. The tables 5043 are configured from a basic data item called an “entity”, and an entity is configured by a series of “properties”. A property expresses one value in the entry. In the present exemplary embodiment, the table is expressed in a tabular format. A row in the table is termed an entity and a column is termed a property.

FIG. 5A illustrates a queue management table 601. The queue management table 601 is a table for management of information related to messages stored in the respective queues 5042 (queue information). More specifically, the queue management table 601 includes data items such as a queue ID and a message ID list. The queue ID is identification information for unique identification of the queue. The message ID list is a message ID list representing identification information for a message stored in the queue. The front-end processing unit 5021 illustrated in FIG. 4 stores queue information in the queue management table 601. The messages stored in the respective queues are messages that have been grouped by the front-end processing unit 5021. More specifically, the front-end processing unit 5021 groups the messages to achieve the same execution processing cost (for example, processing time) for a job contained in the message (divided job). That is to say, the storing unit provided in the front-end processing unit 5021 stores messages including a divided job that has the same execution processing cost in the same queue, and stores the correspondence information between the queue and the message as queue information in a predetermined storage unit (storage).

FIG. 5B illustrates an example of the message management table 602. The message management table 602 stores divided job information that includes data items such as a message ID, an execution order, a queue ID, and a process. The message ID is configured by message identification information. The execution order is the execution order for the job (divided job) contained in the message showing the message ID. The queue ID is identification information for the queue that stores a message that exhibits the message ID. The entry for Process exhibits the processing state of each message. “Processing” means that the back-end processing unit 5031 is processing a message. “Not processing” means that the back-end processing unit 5031 is not processing a message. The front-end processing unit 5021 stores divided job information illustrated in FIG. 5B in the storage. In other words, the front-end processing unit 5021 associates the message, the execution order for the divided job contained in the message, and the queue that stores the message, and stores the information as divided job information in the storage unit.

The back-end processing unit 5031 (provided in the document processing system) accesses a queue management table 601 when commencing processing and refers to queue information. The back-end processing unit 5031 acquires the message ID for the message at the head of the list for each queue (for example, the Message 3, Message 1 illustrated in FIG. 5A). In this manner, the back-end processing unit 5031 recognizes the message stored at the head of each queue. The back-end processing unit 5031 selects the queue that acquires the message by use of the message ID at the head of each acquired queue and the divided job information stored in the message management table 602. More specifically, the back-end processing unit 5031 acquires the execution order for divided jobs contained in the recognized message based on divided job information. The back-end processing unit 5031 examines the message at the head of each queue and selects the message that is first in the execution order among the divided jobs contained in the message of the jobs that are not currently being processed. Then the back-end processing unit 5031 accesses the queue that stores the selected message to obtain the message, and executes the divided job contained in the obtained message. In other words, the back-end processing unit 5031 obtains the message from the queue that stores the message that includes the divided job that is first in the execution order, and executes the divided job contained in the message. In this manner, processing of messages is possible while maintaining the order for execution.

FIG. 6 illustrates an example of a message stored in the queue. The message illustrated in FIG. 6 is a message that is stored in the queue 5042 when a printing request is received by the document processing system 102 from the image forming apparatus 103 and the request corresponds to the contents included in a plurality of pages. The message includes a Message ID, a Processing, a Device, a Contents ID, a Page, and a Contents Path. The Message ID is a message ID. The Processing describe the details of the job to be executed. In this example, a print data conversion process is designated as the Processing. The Device is the processing apparatus (image forming apparatus 103) that is the source of outputting the printing request. The Contents ID is identification information for contents that are stored by the document storage unit 4012 of the document repository 101. The contents are the contents that are the object of the print data conversion process. The Page is the number of object pages for the print data conversion process. The Contents Path is the path on the document repository 101 that stores the contents that is the object of the print data conversion process. The message includes an account name and password required for accessing the document repository 101. Since the information stored in the message can be freely changed, an arbitrary process can be performed in relation to arbitrary contents by storing the required information.

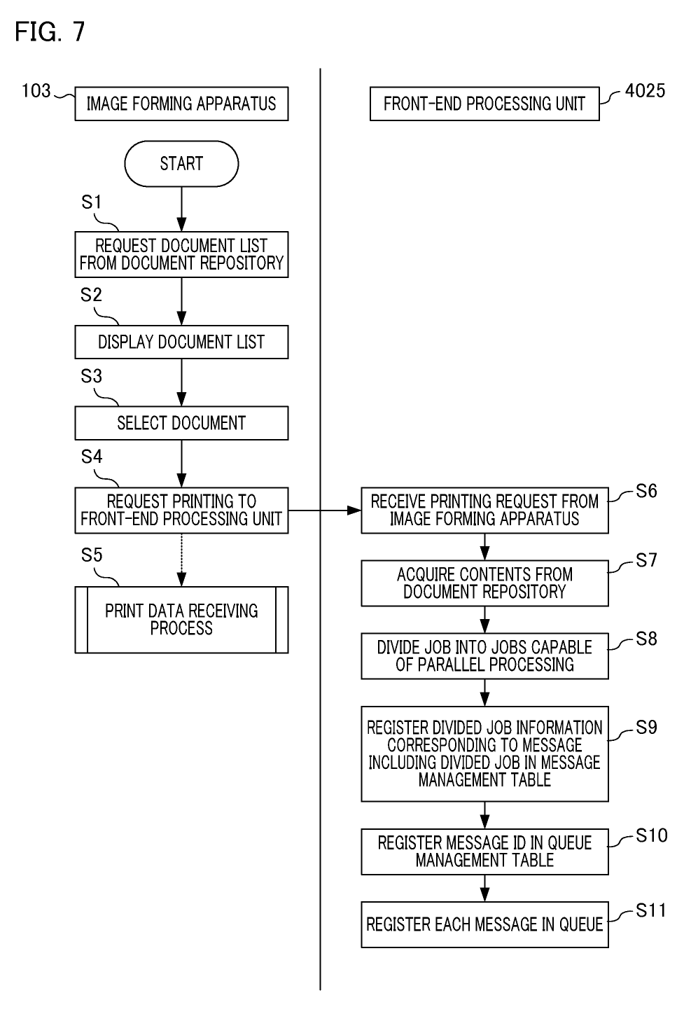

The document processing according to a first exemplary embodiment of the present invention will be described making reference to FIGS. 7 to 9. FIG. 7 is a flowchart describing a registration process for a message in the queue. Firstly, the image forming apparatus 103 requests a list of documents in the document repository 101 from the Web service unit 4011 (step S1) that are designated using the web browser 4034. When the format of the acquired document list information is a format that is explicable to the image forming apparatus 103, there is no particular designation. Next, the image forming apparatus 103 displays the acquired document list information on the web browser 4034 (step S2). Then the image forming apparatus 103 selects the document to be printed from the displayed document list information (step S3). The method of document selection is executed via the user interface 4033 such as a touch panel, keyboard, mouse or the like.

The image forming apparatus 103 sends a printing request to the front-end processing unit 4025 of the document processing system 102 (step S4). The printing request includes setting information or the like when printing using information that uniquely identifies the selected document. The information that uniquely identifies the selected document includes information indicating the storage location of the document in the document repository 101. A unique ID is allocated to each document when the document repository stores contents, and the document can be uniquely identified using the ID. After the image forming apparatus 103 sends the printing request, the image forming apparatus 103 executes a print data receiving process (step S5).

The front-end processing unit 4025 receives the printing request sent from the image forming apparatus 103 (step S6). The front-end processing unit 4025 acquires information for the contents to be the object of processing from the document repository 101 based on the information contained in the received printing request (step S7). Then, the front-end processing unit 4025 divides the job shown in the printing request received from the image forming apparatus 103 into job units that are capable of parallel processing to enable print data conversion processing for each page (step S8). In other words, the storing unit provided in the front-end processing unit 4025 produces a divided job by dividing the document processing job into document page units. Then the front-end processing unit 4025 allocates an execution order for the print data conversion processing of each page (refer to FIG. 5B) into an sequence from a value of 1 according to the page order so that print data conversion processing is performed in accordance with the page order. The front-end processing unit 4025 sums the largest values in the execution order in the message that is stored in the current message management table 602 for each execution order. In this manner, print data conversion processing is performed in order from objects that have small page numbers. The front-end processing unit 4025 then calculates the processing time that is required for print data conversion processing for each page.

Next, the front-end processing unit 4025 registers the divided job information corresponding to the message containing the divided job in the message management table 602 (step S9). The registered divided job information includes the message ID that uniquely identifies each message, the execution order for each message, the queue ID that uniquely identifies the queue in which the message is stored, the process that exhibits the processing state. When there is a queue that has an invisible period that is longer than the processing time for print data conversion processing calculated in step S8 and the invisible period that is set within a predetermined time range, the front-end processing unit 4025 registers that queue ID as the queue ID. The time range above can be freely determined by a provider of the services on the document processing system 102. The dimension of the time range depends on the calculation processing for processing time executed in step S8. When the calculation for the processing time is executed accurately, the time range may be small. Conversely, when the calculation of the processing time is not accurate, the time range must be of a certain size. Furthermore, when there is not a queue that has the above invisible period setting, the front-end processing unit 4025 prepares a queue with a predetermined invisible period setting, and registers the ID of that queue ID as the queue ID. Then the front-end processing unit 4025 sets “not processing” as the process in the message management table 602.

Next, the front-end processing unit 4025 registers the message ID contained in the divided job information, that is registered in the message management table 602, in the queue management table 601 (step S10). More specifically, the front-end processing unit 4025 acquires a queue ID and a message ID contained in the divided job information registered in the message management table 602. Then, the front-end processing unit 4025 adds the acquired message ID to the message ID list corresponding to the acquired queue ID in the queue management table 601. Next, the front-end processing unit 4025 registers each message into the queue 5042 (step S11). The front-end processing unit 4025 transfers the print data conversion process to the back-end processing unit 4024 by the processing executed in step S11.

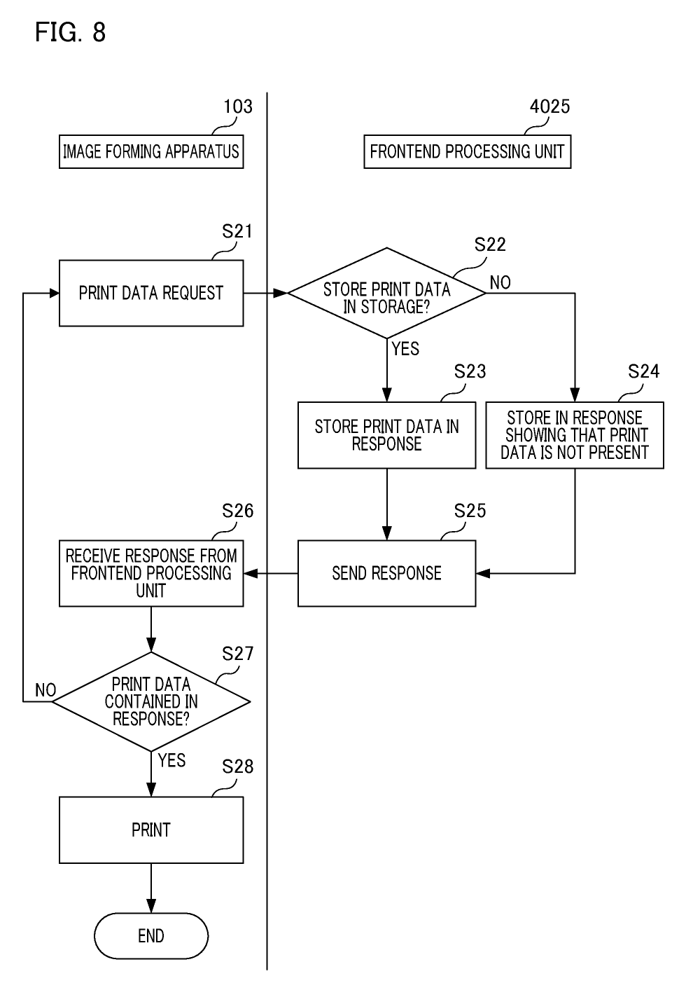

FIG. 8 illustrates a transmission process for print data from the document processing system to the image forming apparatus. Steps S21 to S28 in FIG. 8 correspond to the print data reception processing in step S5 of FIG. 7. Firstly the image forming apparatus 103 sends a print data request to the front-end processing unit 4025 in order to acquire a document that has been print data conversion processed (step S21). The print data request includes the ID of the document for which transmission is requested (document ID). Then the front-end processing unit 4025 receives the print data request from the image forming apparatus 103, and determines whether the print data corresponding to the received document ID is stored in the storage 4021 (step S22).

When the print data corresponding to the received document ID is stored in the storage 4021, the processing proceeds to step S23. When the print data corresponding to the received document ID is not stored in the storage 4021, the processing proceeds to step S24. In step S23, the front-end processing unit 4025 acquires the print data from the storage 4021, stores the print data in the response to be sent to the image forming apparatus 103, and the processing proceeds to step S25. The front-end processing unit 4025 stores the print data in a response that has an arbitrary format that is adapted to the image forming apparatus 103. In step S24, the front-end processing unit 4025 stores information in the storage that shows that the print data does not exist (step S24), and the processing proceeds to step S25. The front-end processing unit 4025 returns the response to the image forming apparatus 103 as an answer to the print data request (step S25).

Next, the image forming apparatus receives the response from the front-end processing unit 4025 (step S26). The image forming apparatus 103 determines whether the print data is contained in the received response (step S27). When the print data is not contained in the received response, the processing returns to step S21. When the print data is contained in the received response, the image forming apparatus 103 executes a printing process using the print data (step S28).

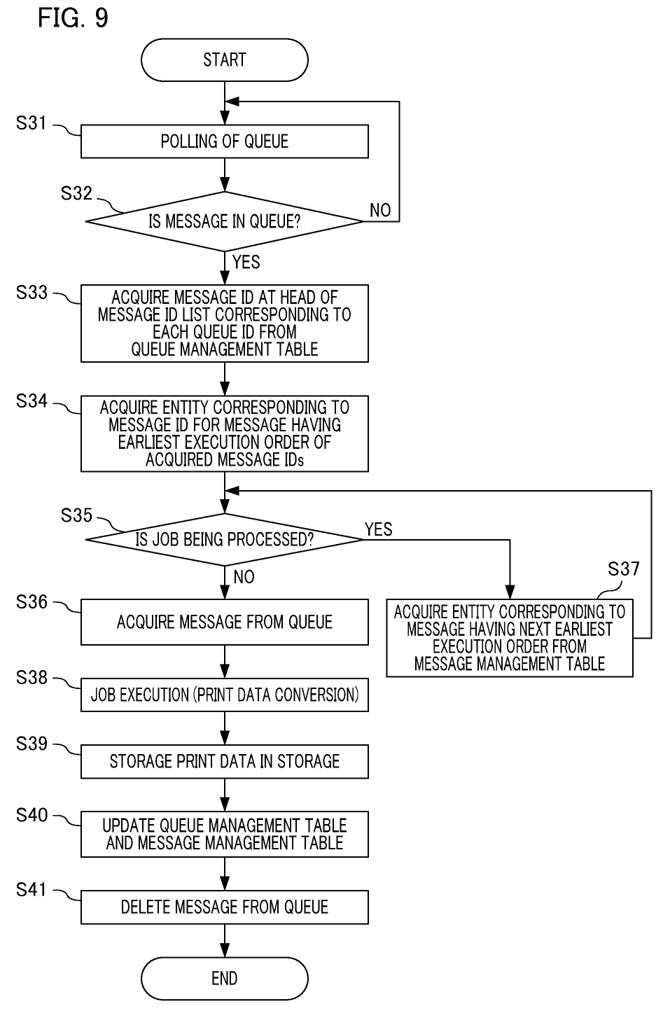

FIG. 9 is a flowchart describing document processing in relation to the back-end processing unit. In FIG. 9, the description will use a value of 1 as the instance number of the back-end processing unit 5031. However, the same operation is executed when a plurality of back-end processing units 5031 is present. In other words, parallel processing is possible when using a plurality of back-end processing units 5031.

Firstly, the back-end processing unit 5031 polls the queue 5042 (step S31). Since a notification for a message from the front-end processing unit 4025 is executed through the queue 5042, the back-end processing unit 5031 polls the queue constantly when processing is not executed. Then, the back-end processing unit 5031 uses the result of the polling to determine whether a message is registered in the queue 5042 (step S32). When a message is not registered in the queue 5042, the processing returns to step S31. When a message is registered in the queue 5042, the processing proceeds to step S33.

Next, the back-end processing unit 4024 accesses the queue management table 601, and acquires the message ID that is registered at the head of the message ID list corresponding to the respective queue IDs (step S33). Then, the back-end processing unit 4024 acquires the entity corresponding to the message ID for the message that is first in the execution order among the message IDs acquired in step S33 from the message management table 602 (step S34). The message corresponding to the entity acquired in step S34 is the message that should be processed first.

Next, the back-end processing unit 4024 refers to the processing contained in the acquired entity, and determines whether the job contained in the message is being processed (step S35). When the job is not being processed, “not processing” is set as the process contained in the entity, and the processing proceeds to step S36. When the job is being processed, “processing” is set to the processing contained in the entity, and the processing proceeds to step S37. In step S37, the back-end processing unit 4024 acquires the entity corresponding to the message that is second in the execution order from the message management table 602 (step S37), and the processing returns to step S35.

In step S36, the back-end processing unit 4024 acquires the message from the queue that corresponds to the queue ID contained in the entity acquired in step S34 (step S36). Then the back-end processing unit 4024 executes the job contained in the message based on the acquired message (step S38). More specifically, the back-end processing unit 4024 accesses the path on the document repository 101 that is contained in the message, and acquires the contents for the designated page. Then the back-end processing unit 4024 converts the contents into print data in accordance with the setting information for printing that is contained in the printing request (step S4 in FIG. 7) (step S38).

Then, the back-end processing unit 4024 stores the print data in the storage 4021 (step S39). The back-end processing unit 4024 gives information that enables unique identification of the data to the storage 4021 as metadata. The back-end processing unit 4024 updates the queue management table 601 and the message management table 602 (step S40). More specifically, the back-end processing unit 4024 deletes the entity corresponding to the message in relation to which processing has been completed from the message management table 602. The back-end processing unit 4024 updates the message ID list corresponding to the queue ID for the queue of the acquired message from the queue management table 601. Then the back-end processing unit 4024 deletes the message in relation to which processing has been completed from the queue (step S41).

According to the document processing system in the first exemplary embodiment, all activated VMs are used to enable print data conversion, and thereby suppresses costs. Furthermore, the document processing system in the first exemplary embodiment enables print data conversion in a suitable order in accordance with the page order.

Next, a second example will be described. The configuration of the document processing system according to the second exemplary embodiment has the same configuration as the document processing system according to the first exemplary embodiment. The document processing system according to the second exemplary embodiment executes overlapping processing of the form data and the print data (form combination processing). Form combination processing includes a production process for form data (hereinafter referred to as “form registration processing”), a production process for print data (hereinafter referred to as “print data conversion processing”), and a combination processing for the form data and the print data (hereinafter referred to as “combination processing”).

The storing unit provided in the front-end processing unit 4025 executes the following processing when the request details related to document processing received from the image forming apparatus 103 relate to form combination processing. The front-end processing unit 4025 produces divided jobs corresponding to the form registration processing, the print data conversion processing or the combination processing contained in the form combination processing. The front-end processing unit 4025 stores the divided jobs in a plurality of queues after determining the execution order for each of the divided jobs.

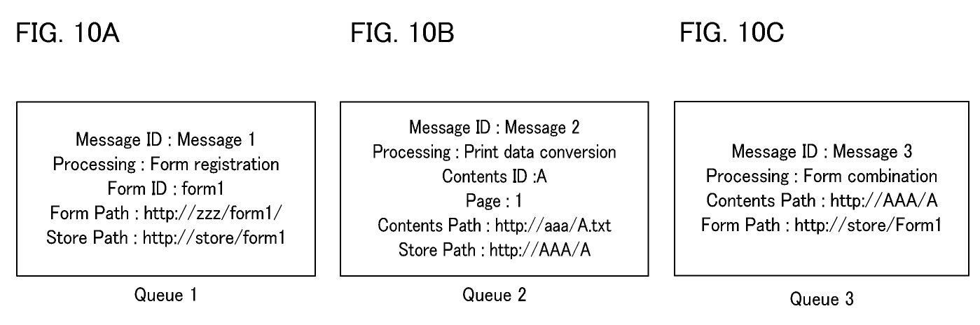

FIGS. 10A to 10C illustrate an example of a message stored in the queue according to the second exemplary embodiment. FIG. 10A is an example of a message for form registration processing. FIG. 10B is an example of a message for print data conversion processing. FIG. 10C is an example of a message for combination processing. The form registration processing message illustrated in FIG. 10A includes a Message ID, a processing details, a Form ID, a Form Path, and a Store Path. The Message ID is the ID of the message. The processing details show the details of the job to be executed. In the present example, a form registration is designated as the processing details. The Form ID is identification information for unique identification of the form data used in form combination. The Form Path is the path to a location at which the form data is stored. The Store Path is the path to the registration destination for the form. The message for form registration processing includes the account name or password required for accessing the document repository 101.

The print data conversion message illustrated in FIG. 10B includes a Message ID, a processing details, a Contents ID, a Page, a Contents Path, and a Store Path. In this message, print data conversion is designated as the Processing, and the message includes the Contents ID, the Page, Contents Path, and the Store Path. The Contents ID is the identification information of the contents stored in the document storage unit 4012 of the document repository 101. The contents are those contents that will be the object of print data conversion processing. The Page is the number of pages to be the object of print data conversion processing. The Contents Path is the path on the document repository that stores the contents to be the object of print data conversion processing. The Store Path is the path to the storage destination for data after conversion.

The message for combination processing illustrated in FIG. 10C includes a Message ID, a processing details, a Contents Path, and a Form Path. The message designates the form combination as the processing details. The Contents Path is the path to the location for storage of the print data used during form combination. The Form Path is the path to the location for storage of the form data used during form combination.

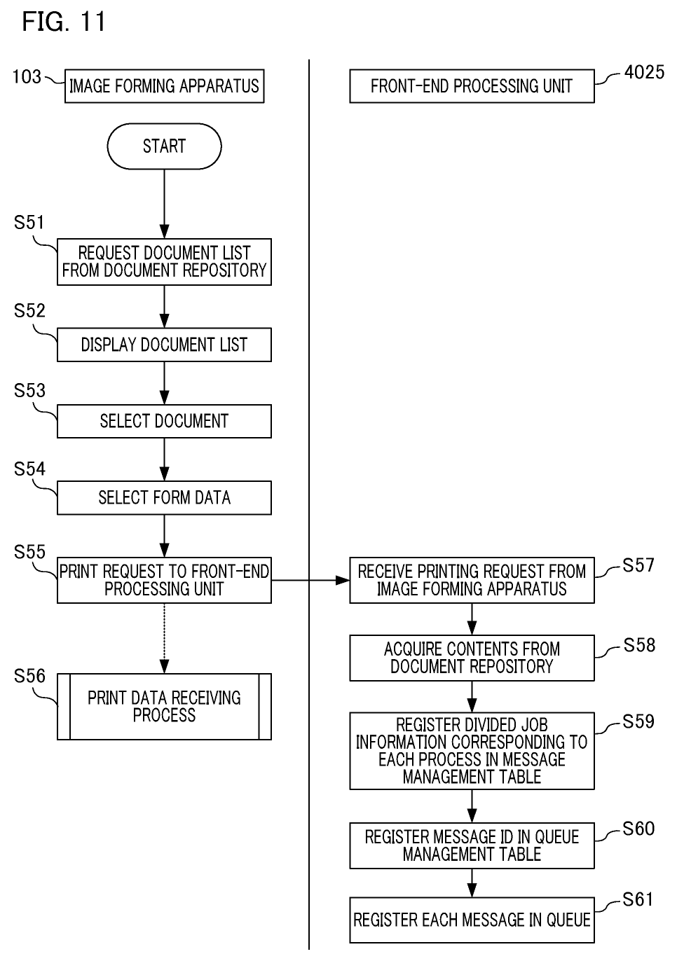

FIG. 11 is a flowchart describing registration processing for a message in the queue according to the second exemplary embodiment. Steps S51 to S53 illustrated in FIG. 11 are the same as steps S1 to S3 illustrated in FIG. 7. Steps S56 to S58 in FIG. 11 are the same as steps S5 to S7 in FIG. 7. In step S54 in FIG. 11, the image forming apparatus 103 selects form data for use in a form combination (step S54). In step S54, the image forming apparatus 103 uses the web browser 4034 to select the form data that is present on the network 100. Then, the image forming apparatus 103 sends information for unique identification of the selected document, setting information during printing operations, and information for unique identification of the form data. The information for unique identification of the selected document is information indicating the storage location of a document in the document repository 101. An ID is allocated uniquely to each document during storage of contents on the document repository 101 to thereby enable unique identification using the allocated ID. Furthermore the information for unique identification of form data is information (form ID) indicating the storage location of form data.

In step S59, the front-end processing unit 4025 of the document processing system 102 registers divided job information corresponding to the form registration process, the print data conversion process, or the combination process in the message management table 602 (step S59). The front-end processing unit 4025 for example, registers the divided job information in the order of divided job information corresponding to form registration processing, divided job information corresponding to the print data conversion process, and divided job information corresponding to combination processing. The front-end processing unit 4025 allocates an execution order for the print data conversion processing for each page in the message management table 602 at least in relation to divided job information corresponding to the print data conversion processing so that print data conversion processing is executed in the order of pages.

Next, the front-end processing unit 4025 registers the message ID in the queue management table 601. The message ID is contained in the divided job information that is registered in the message management table 602 (step S60). The front-end processing unit 4025 registers each message in the queue (step S61). The sending process for print data in relation to the image forming apparatus from the document processing system in the second exemplary embodiment is the same as the sending process for print data described with reference to FIG. 8.

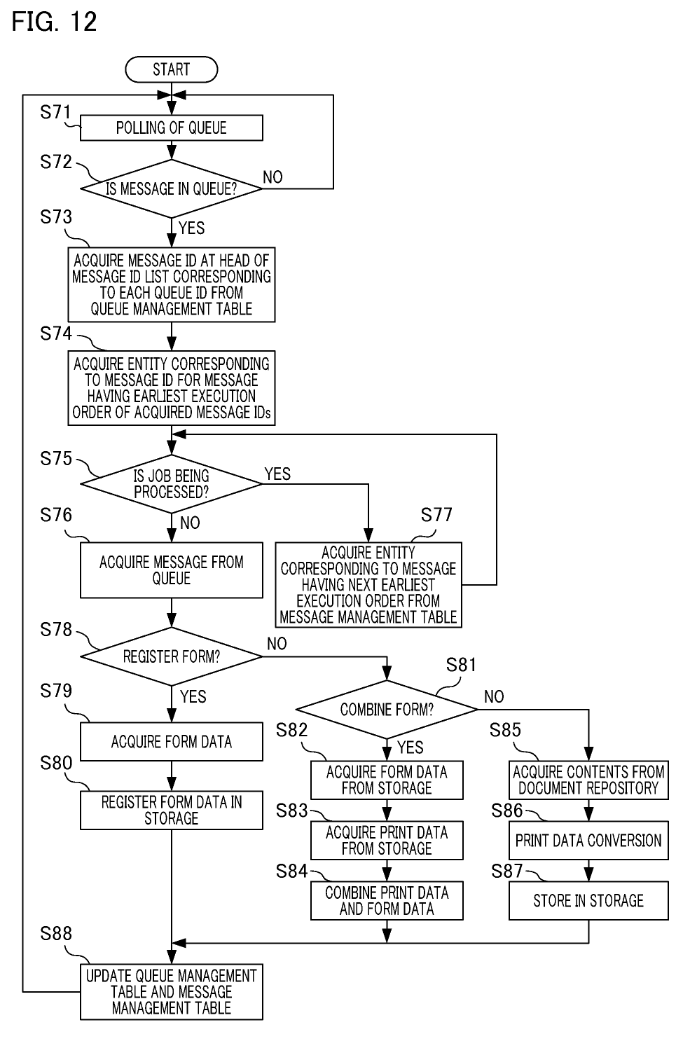

FIG. 12 is a flowchart describing document processing by the back-end processing unit according to the second exemplary embodiment. In FIG. 12, the description will use a value of 1 as the instance number in the back-end processing unit 5031. However, the same operation is executed in relation to a plurality of back-end processing units 5031. In other words, parallel processing is possible when using a plurality of back-end processing units 5031. Steps S71 to S77 in FIG. 12 is the same as steps S31 to S37 in FIG. 9. Furthermore, step S88 in FIG. 12 is the same as step S40 in FIG. 9.

Firstly, in step S78 in FIG. 12, the back-end processing unit 5031 determines whether the Processing contained in the message acquired from the queue relate to a form registration (step S78). When the Processing contained in the message acquired from the queue relate to a form registration, the processing proceeds to step S79. When the Processing contained in the message acquired from the queue do not relate to a form registration, the processing proceeds to step S81.

In step S79, the back-end processing unit 5031 acquires form data based on the Form Path (refer to FIG. 10A) contained in the acquired message (step S79). The back-end processing unit 5031 stores the acquired form data in the storage 5041 (step S80). The back-end processing unit 5031 also stores the form ID (refer to FIG. 10A) contained in the acquired message in the storage 5041.

In step S81, the back-end processing unit 5031 determines whether the message acquired from the queue is form combination information (step S81). When the message acquired from the queue is form combination information, the processing proceeds to step S82. When the message acquired from the queue is not form combination information, the processing proceeds to step S85.

In step S82, the back-end processing unit 5031 acquires the form data from the storage 5041 based on the Form Path contained in the message (refer to FIG. 10C) acquired from the queue (step S82). Then, the back-end processing unit 5031 acquires the print data from the storage 5041 based on the Contents Path contained in the message (step S83). The back-end processing unit 5031 combines the print data and the form data (step S84), and the processing proceeds to step S88.

In step S85, the back-end processing unit 5031 acquires the contents to be object of the printing conversion processing from the document repository 101 based on the Content Path contained in the acquired message (refer to FIG. 10B) (step S85). The back-end processing unit 5031 executes print data conversion on the acquired contents (step S86). The back-end processing unit 5031 stores the print data obtained from print data conversion in the storage 5041 (step S87), and the processing proceeds to step S88.

According to the document processing in the second exemplary embodiment, before the document processing system 102 executes form combination, registration processing and print data conversion processing of the form data is executed. Therefore, execution of jobs required for form combination can be executed in a suitable order.

The document processing system according to each exemplary embodiment and each example above enables execution of parallel document processing using all activated VMs. When executing parallel processing, improvement to processing speed is possible by processing in a suitable order that takes the processing order into account.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-126451 filed Jun. 2, 2010, which is hereby incorporated by reference herein in its entirety.

What is claimed is:

1. A cloud computing system comprising:
a request reception unit configured to be realized by executing a request reception program that stores a message corresponding to a job in a storage unit in response to the reception of a processing request for the job from an image forming apparatus; and
a back-end processing unit configured to be realized by executing a back-end processing program that makes an acquisition request for the message to the storage unit at regular intervals, and when the message has been acquired from the storage unit, performs processing based on the acquired message,
wherein the request reception unit includes a storing unit configured to receive a processing request for a job from the image forming apparatus, divide the received job, determines the execution order for each of the divided jobs, and store a message corresponding to each of the divided jobs in a plurality of the storage units; and
wherein the back-end processing unit includes a document processing unit configured to obtain the message stored in any one of a plurality of the storage units in accordance with the determined execution order for the divided jobs, execute document processing for the divided jobs based on the obtained message, and store the document processing result in the storage unit.

2. The cloud computing system according to claim 1, wherein the storage unit receives a request related to the document processing from the image forming apparatus, produces the divided jobs by dividing the document processing job into units that are capable of parallel processing in response to received request details, and determines the execution order for each of the divided jobs, and then stores the message including the divided jobs in the plurality of queues; and
the document processing unit obtains the divided job contained in the message stored in the queue in accordance with the determined execution order for the divided job, performs document processing by executing the obtained divided job, and returns the document processing result to the image forming apparatus.

3. The cloud computing system according to claim 2, wherein the storage unit stores the messages that include a divided job that has the same execution processing cost in the same queue, stores the correspondence information for the queue and the message as queue information, creates an association between the message, the execution order of the divided job contained in the message, and the queue that stores the message, and stores as divided job information; and
the document storage unit recognizes the message stored at the head of each queue by referring to the queue information, acquires an execution order for the divided job contained in the recognized message based on the stored divided job information, obtains the message from the queue that stores the message that contains the divided job that is first in the execution order, and executes the divided job contained in the message.

4. The cloud computing system according to claim 2, wherein the storage unit produces the divided jobs by dividing the document processing job into document page units.

5. The cloud computing system according to claim 2, wherein, when the request details relating to the document processing received from the image forming apparatus relate to a form combination processing that executes overlapping processing of form data and print data, the storage unit produces a divided job corresponding to the combination process of the form data and print data, or to a production process for the printing data, or to a production process for the form data contained in the form combination process.

6. A document processing method comprising the steps of:
storing, in a storing step, a message corresponding to a job in response to the reception of a processing request for the job from an image forming apparatus using a request reception unit configured to be realized by executing a request reception program; and
making, in a processing step, an acquisition request for the message to the storage unit at regular intervals, and when the message has been acquired from the storage unit, performing processing based on the acquired message using a back-end processing unit configured to be realized by executing a back-end processing program,
wherein, in the storing step, the request reception unit receives a processing request for a job from the image forming apparatus, divides the received job, determines the execution order for each of the divided jobs, and stores a message corresponding to each of the divided jobs in the storage unit; and
wherein, in the processing step, the back-end processing unit obtains the message stored in any one of the plurality of storage units in accordance with the determined execution order for the divided jobs, executes document processing for the divided jobs based on the obtained message, and stores the document processing result in the storage unit.

7. A computer readable storage medium on which is stored a computer program for making a computer execute a method for a document processing method, the method comprising the steps of:
storing, in a storing step, a message corresponding to a job in response to the reception of a processing request for the job from an image forming apparatus using a request reception unit configured to be realized by executing a request reception program; and
making, in a processing step, an acquisition request for the message to the storage unit at regular intervals, and when the message has been acquired from the storage unit, performing processing based on the acquired message using a back-end processing unit configured to be realized by executing a back-end processing program,
wherein, in the storing process, the request reception unit receives a processing request for a job from the image forming apparatus, divides the received job, determines the execution order for each of the divided jobs, and stores a message corresponding to each of the divided jobs in the storage unit; and
wherein, in the processing process, the back-end processing unit obtains the message stored in any one of the plurality of storage units in accordance with the determined execution order for the divided jobs, executes document processing for the divided jobs based on the obtained message, and stores the document processing result in the storage unit.
